(19) United States
(12) Patent Application Publication
(10) Pub. No.: US 2024/0150131 A1
(43) Pub. Date: May 9, 2024

(54) CABLE STACKER

(71) Applicant: Schleuniger AG, Thun (CH)

(72) Inventors: Roland KAMPMANN, Witten (DE); Manuel BÜGLER, Essen (DE); Michael BÖHM, Hückeswagen (DE)

(73) Assignee: Schleuniger AG, Thun (CH)

(21) Appl. No.: 18/549,394

(22) PCT Filed: Mar. 9, 2022
(86) PCT No.: PCT/IB2022/052114

§ 371 Date: Sep. 7, 2023

(30) Foreign Application Priority Data
Mar. 9, 2021 (WO) PCT/IB2021/051953

(51) Int. Cl. B65G 47/24; B65G 21/20; B65G 47/44

(52) U.S. Cl. CPC B65G 47/24; B65G 21/2072; B65G 47/44; B65G 2201/0217

(57) ABSTRACT

A cable stacker comprising a belt conveyor (21) for conveying the cable along a conveying direction, a discharge device for dropping a cable into a collection tub (241), and a guide element (50) for damping a meandering movement of the cable that is to be put down.

The invention relates to cable stackers, cable-processing devices with a cable stacker, and methods for safely transporting a cable according to the independent patent claims.

Cable stackers are typically stand-alone fixtures and are typically placed on cable-processing devices. Such cable stackers have a belt conveyor with a first conveyor roller and at least one further conveyor roller, wherein at least one of the two conveyor rollers is driven by a conveyor drive device. A belt is typically arranged on the conveyor rollers, which moves a processed cable along a conveyor track when the belt conveyor is activated.

U.S. Pat. No. 4,793,759 A discloses a cable stacker with a first belt conveyor for conveying the cable along a conveying direction, wherein the first belt conveyor comprises a conveyor track with an inlet track section and an outlet track section. There is a main frame on which the first belt conveyor is placed, wherein there is counter-barrier for guiding the cable.

The disadvantage of this well-known solution is that in the case of a cable-processing process at a high production frequency, such a mechanism for dropping the cable off the conveyor track can be faulty.

DE 10 2017 202 502 A1 relates to a conveying device for cables, which comprises a conveyor belt for conveying a cable piece. The conveying device comprises a profile element which can be moved across the conveyor belt transversely to the conveying direction in order to convey the cable piece from the conveyor belt into a collection flap in a controlled manner.

The disadvantage of this well-known solution is that in a cable-processing process at a high production frequency, such a mechanism for dropping the cable from the conveyor belt is too slow.

The object of the present invention is to provide an improved cable stacker which, in particular, does not comprise at least one of the aforementioned disadvantages. In particular, a cable stacker is modified into a high-performance cable stacker because the placement speed is increased, and incorrect placements can be reduced.

The task is solved by means of the features of independent claims. Favourable further embodiments are shown in the figures and in the dependent patent claims.

A cable stacker according to the invention comprises a first belt conveyor for conveying the cable along a conveying direction, wherein the first belt conveyor is suitable for accommodating a belt and the first belt conveyor comprises a conveyor track with an inlet track section and an outlet track section. Furthermore, there is a main frame on which the first belt conveyor is arranged, wherein there is a counter-barrier for guiding the cable. The first belt conveyor comprises a first discharge barrier in the area of the inlet track section to prevent uncontrolled sliding of the cable off the conveyor track, wherein the first discharge barrier can be moved at least into an active position relative to the counter-barrier.

The first discharge barrier can be moved vertically towards the counter-barrier and/or horizontally to the counter-barrier. If the first discharge barrier is in its active position, it serves as an obstacle to the leading cable end of a cable. In addition to guiding the cable, a counter-barrier is also suitable for preventing the cable from sliding off the conveyor track in an uncontrolled manner. The leading cable end cannot overcome the discharge barrier in the conveying process along the conveying direction if the discharge barrier is in its active position. An uncontrolled sliding of the cable off the conveyor track can thus be avoided so that the placement speed can be increased and, simultaneously, incorrect placements can be reduced. For example, the first discharge barrier is adjacent to a first conveyor roller of the belt conveyor. In the area of the outlet track section, another conveyor roller can be arranged, which can be actively driven or moved by a conveyor drive device.

The counter-barrier is preferably arranged in the inlet track section of the conveyor track so that it is at least opposite the first discharge barrier on the cable stacker. Thus, the guidance of the cable is further improved.

Preferably, the first discharge barrier can be moved from the active position to an inactive position orthogonally to the conveying direction. The first discharge barrier can be moved towards the conveyor track or away off the conveyor track, for example, lowered or raised (vertically). The first discharge barrier does not cross the conveyor track of the belt conveyor so that the processed cable can be conveyed onto the conveyor track in an unhindered manner.

In addition, or as an alternative, the first discharge barrier can be moved along the conveying direction of the conveyor track. The first discharge barrier can be small and compact. Depending on the cable length and/or cable type, the first discharge barrier can be positioned along the conveying direction of the conveyor track on the cable stacker.

Preferably, the first discharge barrier is mechanically connected to a drive device with at least one drive for moving the first discharge barrier. The drive can be designed as an electric drive so that the first discharge barrier can be easily moved.

Preferably, the drive device is a pneumatic drive device, which comprises at least one pneumatic cylinder as a drive. This means that the first discharge barrier can be easily transferred from the active position to the inactive position.

Preferably, this drive device comprises a valve. The valve can be designed as a compressed-air valve and, for example, be part of a valve battery. With a valve, the electrical control signals can be easily converted into compressed-air levels, which ensures a controlled compressed-air supply to the pneumatic cylinder.

Preferably, a control device is available, which is at least electrically connected to the drive device for the exchange of control data. This allows the drive device to be controlled in a reproducible manner. For example, the control device comprises a computing unit and is connected to a memory and/or database for the exchange of control data.

Preferably, a sensor device is available, using which at least the inactive position of the first discharge barrier can be detected. The sensor device detects the inactive position of the first discharge barrier and forwards corresponding sensor data to the control device. The sensor data can be further processed in the computing unit of the control device. In addition, or as an alternative, a sensor device is available, using which at least the active position of the first discharge barrier can be detected. The sensor device detects the active position of the first discharge barrier and forwards corresponding sensor data to the control device. The sensor data can be further processed in the computing unit of the control device to form control commands, at least for the first discharge barrier. For this purpose, this sensor device is electrically connected to the control device for the exchange of sensor data.

Preferably, the counter-barrier is moveably arranged on the first belt conveyor. The counter-barrier can be moved by hand by a user or be connected to an adjustment mechanism that moves the counter-barrier in a motorized or pneumatic manner. This makes it possible, for example, to set a gap between the counter-barrier and the conveyor track, particularly if a new belt has been arranged on the first belt conveyor so that the processed cable can be prevented from jamming on the belt conveyor.

Preferably, the first belt conveyor is tilted relative to the horizontal on the main frame. The first belt conveyor is twisted or tilted around the conveying direction, making it difficult for the cable to slide off the conveyor track. In particular, the tilt is between 1 degree and 15 degrees. Preferably, the tilt is 6 degrees. This means that premature discharge of the cable can be prevented or the desired controlled sliding of the cable off the conveyor track is still possible.

Preferably, there is a collection area for the collection of the cables, wherein the first discharge barrier is arranged adjacent to the collection area. Those processed cables that are to overcome the first discharge barrier can be safely stored in the collection area.

Preferably, the collection area is designed as a moveable collection tub. The collection tub can be easily tilted using a pneumatic cylinder, for example, moved from one end position (tilted up) to another end position (tilted down). For example, a repository tub can also be available to store the processed cables when they are conveyed from the tilted collection tub to the repository tub.

Preferably, a belt is placed on the first belt conveyor for transporting the cable along the conveying direction. A belt can be easily positioned on the belt conveyor in a reproducible manner and be fixed with the aid of a clamping device.

Preferably, the belt is a flat conveyor belt. A flat conveyor belt has no longitudinal profile (or belt bead) and is easy to manufacture and cheap to produce compared to a belt with a longitudinal profile. In particular, the flat conveyor belt comprises a structure with increased adhesion on its supporting side opposite the running side or its outer surfaces so that the processed cables can be conveyed more easily. The running side of a flat conveyor belt is typically operatively connected to at least one conveyor roller. Alternatively, the belt can be a toothed belt.

Preferably, a moveable protective cover is arranged along the conveying direction of the first belt conveyor. The protective cover can be removed from the inlet track section of the first belt conveyor to allow a user easy access to the conveyor track.

In particular, the protective cover can be swivelled. For this purpose, the protective cover can be connected to the main frame by means of a hinge and with a snap-in and/or spring mechanism with integrated damper elements (e.g., gas-pressure springs), wherein the damper element fixes the uncovered position and/or reduces the force required when uncovering or distributes it more evenly over the overall movement.

Preferably, the first belt conveyor comprises at least a second discharge barrier to prevent uncontrolled sliding of the cable off the conveyor track, wherein the second discharge barrier is moveable relative to the counter-barrier in an active position. The second discharge barrier can be arranged adjacent to the first discharge barrier to improve the prevention of uncontrolled sliding of the cable.

Preferably, there is at least one fixing device for fixing at least the first discharge barrier in the active position. The fixing device comprises, for example, a stand-alone mechanical, electrical or magnetic fixing unit that prevents the first discharge barrier from being transferred to its inactive position either by blocking its drive device or by blocking the movement of the first discharge barrier. The moveable collection tub can also serve as a fixing device, which prevents the first discharge barrier from being transferred to its inactive position if, for example, it is tilted.

Preferably, the first belt conveyor comprises a plurality of modular frames, which can be connected to the main frame and thus hold onto the cable conveyor in a stable and stationary manner. Such modular frames can be manufactured in standardized sizes so that the conveyor track of the first belt conveyor can be individually adapted or extended. The cable stacker with a modular design still comprises only one belt, a clamping device and at least one belt drive so that the manufacturing costs are not significantly increased, but the customer benefit is significantly improved; additional conveyor rollers can be dispensed with.

In particular, the modular frames can be separated from each other and/or from the main frame so that modularity is improved, and transport and assembly is simplified before the cable stacker is commissioned for the first time.

Preferably, there is at least one other belt conveyor, which can be separated from the first belt conveyor, for transporting the cable along the conveying direction, wherein the first belt conveyor and the other belt conveyor are suitable for holding a single belt so that the manufacturing costs are not significantly increased.

Preferably, a single flat conveyor belt is provided for transporting the cable along the conveying direction. Flat conveyor belts are easy to install in a reproducible manner.

Preferably, another discharge barrier is provided on one of the modular frames and/or on one of the other belt conveyors to prevent uncontrolled sliding of the cable off the conveyor track, wherein the further discharge barrier relative to the counter-barrier can be moved at least into an active position. This prevents the cable from sliding off the conveyor track outside the inlet track section in an uncontrolled manner.

Preferably, there is at least one discharge device for dropping the cable from at least one of the belt conveyors, wherein the discharge device is electrically connected to the control device for exchanging control data. The discharge device can be designed as a swivel arm or a linearly moveable discharge arm so that controlled discharge is possible, and the discharge device is arranged on the cable stacker to save space.

An inventive cable-processing device comprising at least one cable-processing station and at least one cable-processing tool for processing the cable, as well as a cable stacker as described herein, comprises at least one discharge device for dropping the cable from at least one belt conveyor arranged on the cable-processing device or on the cable stacker. The at least one discharge device can thus be part of the cable-processing device or part of the cable stacker. For example, a gripper arranged at the cable-processing station is used as a discharge device and can be used for cable transport between different processing stations and/or for other functions. For example, the gripper is mounted on a swivel arm with a vertical axis of rotation.

Preferably, the discharge device is connected to the control device of the cable stacker for the exchange of control data. This means that at least one discharge device can be installed or put into operation independently of the cable-processing device.

Alternatively, the cable stacker is electrically connected to a central control system of the cable-processing device for the exchange of control data, wherein at least one discharge device is connected to the central control system for the exchange of control data. There is no need for a separate control device for the cable stacker so that the manufacturing costs of the cable stacker are optimized.

An inventive method for safely conveying a cable on a cable stacker, wherein the cable stacker comprises at least one first belt conveyor and a first discharge barrier, shall include at least the following steps:
a) selecting at least one cable parameter;
b) transferring of the first discharge barrier relative to a counter-barrier into an active position;
c) conveying the cable on the first belt conveyor.

An uncontrolled slide of the cable off the conveyor track of the belt conveyor can be avoided so that the placement speed can be increased and simultaneously, incorrect placements are reduced.

The cable parameters here are the cable type (coaxial cable, multi-guide element cable, etc.), the cable geometry (structure, dimensioning, cable length, etc.) as well as the overall structure of the processed cable, wherein the overall structure can also comprise a cable connector arranged on the cable. In particular, the cable stacker is a cable stacker described herein or a cable stacker as part of a cable-processing device as described above.

Preferably, at least one cable parameter is retrieved from a database. The control device or the central control system is connected to the database for the exchange of cable parameters so that cable parameters that have already been stored can be used and the initialization of the cable stacker before the start of production is improved.

Preferably, after step b), at least one cable-processing tool of a cable-processing station is activated. The processing of the cable can therefore only be started when the first discharge barrier is in its active position so that the incorrect placement on the cable stacker is further reduced. In particular, the cable-processing tool of the cable-processing station of the cable-processing device described herein is activated.

Preferably, step c) is followed by the step of transferring the first discharge barrier to an inactive position (step d). In addition, or as an alternative, after step d), the cable is discharged using the discharge device (step e). This means that the cable is reliably discarded without getting caught on the discharge barrier.

Another cable stacker according to the invention comprises a first belt conveyor for conveying the cable along a conveying direction, wherein the first belt conveyor is suitable for accommodating a belt. The cable stacker comprises at least one discharge device for dropping the cable. In the inlet track section of the conveying direction, there is a collection area for collecting the cables. Preferably, the collection area is designed as a (moveable) collection tub. Furthermore, there is a main frame on which the first belt conveyor is arranged, wherein there is at least one first guide element. The guide element is arranged to dampen a meandering movement or unwanted lateral movement of a cable that is to be put down. The first guide element can preferably be positioned longitudinally along the conveying direction of the cable to be conveyed in the inlet track section. With the aid of the first guide element, when the cable is dropped, its guidance in the inlet track section is improved, thereby ensuring optimum storage quality. When the cable is dropped or when the cable is moved laterally (e.g., when swinging back from a processing station in the direction of the belt conveyor), a horizontal meandering movement is formed, for example, triggered by a horizontal swivel movement of the discharge device or the swivel arm, starting from the trailing cable end to the leading cable end. This meandering movement is distinct depending on the cable parameters. For example, the movement is more distinct for short cables and thin cables compared to long and/or thick cables. The geometric shape, for example a dampened vibration, of the meandering movement is determined by the dropping pulse of the discharge device on the cable and the position of the first guide element so that unwanted slipping of the cable is prevented. The position of the first guide element is to be adjusted according to the cable length or cable parameters, wherein the position of the first guide element for short cables is different from the position of the first guide element for long cables and, in particular, the position of the first guide element for thin cables is different from the position of the first guide element for thick cables. The difference is that the shorter the cable, the further the guide element must be shifted towards the lagging cable end. The longer the cable, the further the guide element is shifted towards the leading cable end.

Preferably, the guide element is arranged transversely to the conveying direction and obliquely to the perpendicular. Preferably, the guide element forms an angle β of less than 90°, preferably 50°-80°, being furthermore preferred, 55°-75° with the surface of the conveyor belt. Favourably, the angle β favours the sliding of the cable off the conveyor track into the collection tub. A particularly good result is achieved at an angle of 57°.

Preferably, the guide element is spaced away from the belt conveyor, wherein, preferably, on the plane of the belt conveyor, the distance between the guide element and the belt conveyor is between 20 and 50 mm, preferably between 30 and 40 mm. Favourably, the spaced-away guide element allows the cable to slip through the gap between the belt conveyor and the guide element and subsequent deflection/sagging of the cable, which promotes the cable sliding off the conveyor track into the collection tub.

Preferably, the side of the guide element facing the conveyor track has a rounded shape. This favourably prevents the cable from being damaged during the damping of the meandering movement and reduces any buckling stresses when feeding a lagging cable end to a processing machine.

Preferably, the guide element projects over the top side of the belt conveyor to at least the working height of the discharge device or the gripper above the belt conveyor.

In the area of the first guide element, a sensor device with at least one sensor for determining a first position of the guide element is present in one embodiment, wherein the sensor device is electrically connected to the control device or to the central control system of a cable-processing device. With the aid of the sensor, a positioning error of the first guide element relative to the conveyed cable can be detected so that unwanted slipping of the cable is better prevented. In addition, or as an alternative, in a further embodiment, a drive device for the movement of the guide element is connected to the first guide element. But it doesn't have to be that way. Manual adjustment is also conceivable, wherein a quick-release fastener allows the stabilization or release of the Guide element relative to the base of the belt conveyor. The drive device enables automatic, precise and reproducible positioning of the first guide element on the cable stacker, particularly depending on the cable to be stacked. For this purpose, the drive device preferably comprises a spindle or a pneumatic cylinder, wherein the spindle enables infinitely variable positioning of the first guide element and a pneumatic cylinder is a cost-effective variant of a drive device.

For example, a light barrier, an inductive or magnetic sensor or a switch that detects the first position of the first guide element and can interact with a detection element can be used as a sensor. Alternatively, the drive device can include the sensor, for example by detecting a position of a pneumatic cylinder or the rotational movement of a spindle. The control device or central control system comprises a computing unit and is connected to a database for the exchange of control data. The control data comprises control commands to control the drive device of the first guide element. The computing unit comprises a program that is suitable for evaluating the sensor data and, for example, checking or comparing it with a preselected cable parameter of the cable to be stacked, as well as calculating the first position and comparing it with a reference value from a database. If, for example, the first position of the first guide element differs from the reference value, at least a warning is sent out and, where applicable, a conveyor operation of the belt conveyor is prevented or delayed. Otherwise, the first belt conveyor can start conveying the processed or stacked cable.

Preferably, the drive device for the movement of the guide element is electrically connected to the control device so that the positioning can be carried out in a precisely controlled manner, and can be adjusted, particularly for short cables, long cables, thick cables or thin cables.

Alternatively, the drive device is electrically connected to a central control system of a cable-processing device. This allows control commands to move the first guide element to be created and transmitted directly from the central control system of a cable-processing device and, where applicable, to stop the first belt conveyor. The drive device can include a pneumatic actuator or can also include an electric drive.

Preferably, a protective cover is provided, and the first guide element is placed on the protective cover. This means that the first guide element can be removed together with the protective cover, allowing for improved accessibility to the conveyor belt for the user. For example, the protective cover is a protective cover as described above.

In particular, this protective cover is moveable, preferably tiltable, designed and contains fixing, damper and/or spring elements. These fix the uncovered position of the protective cover and/or reduce the force required when uncovering and/or distribute the force evenly over the overall movement. This improves the ease of use for the user.

An inventive method for safely moving a cable on a cable stacker as described herein comprises the following steps:
a) transfer of the first guide element to a first position, wherein first position is matched to the length of the cable to be transported;
b) checking the first position of the first guide element using the sensor device;
c) transfer of control data to the control device;
d) conveying the cable on the first belt conveyor.

This leads to a reduction in the number of incorrect placements in the cable stacker. If step b) is performed manually by a user, the check in step c) detects that the position measured with the sensor device does not match the required position. This can cause the belt conveyor to stop, and the user can receive a warning/error message.

In particular, before step a) the selection of at least one cable parameter of the cable is carried out. The cable parameters here are the cable type (coaxial cable, multi-guide element cable, etc.), the cable geometry (structure, dimensioning, cable length, etc.) as well as the overall structure of the processed cable, wherein the overall structure can also comprise a cable connector arranged on the cable. In particular, the cable stacker is a cable stacker described herein or a cable stacker as part of a cable-processing device as described above.

Preferably, at least one cable parameter is retrieved from a database. The control device or the central control system is connected to the database for the exchange of cable parameters so that cable parameters that have already been stored can be used and the initialization of the cable stacker before the start of production is improved.

Preferably, the transfer of the first guide element to the first position in step b) is carried out with the aid of the drive device. This allows the first guide element to be set fully automatically.

A cable stacker according to the invention comprises a first belt conveyor for transporting the cable along a conveying direction, wherein the first belt conveyor is suitable for accommodating a belt. Furthermore, there is a main frame on which the first belt conveyor is arranged, wherein there is a counter-barrier for guiding the cable. The counter-barrier can be moved relative to the conveying direction in order to set a gap to the conveyor track of the first belt conveyor.

The moveable counter-barrier can be used to adjust a gap between the belt and the counter-barrier when the belt is arranged on the first belt conveyor so that unwanted clamping of the processed cable in this gap can be prevented. This leads to a reduction in the number of incorrect placements in the cable stacker.

Preferably, the counter-barrier is normally moveable to the conveying direction to vertically adjust a horizontal gap between the first belt conveyor and the counter-barrier. This prevents unwanted clamping of the processed cable in the horizontal gap.

In addition, or as an alternative, the counter-barrier can be moved normally to the conveying direction in order to horizontally adjust a vertical gap between the first belt conveyor and the counter-barrier. This prevents unwanted clamping of the processed cable in the vertical gap.

Preferably, the belt is designed as a flat conveyor belt. A flat conveyor belt has at least one belt transport surface and at least one belt end face. A flat conveyor belt does not have any longitudinal profile and, in comparison with a belt with a longitudinal profile, it is easy to construct and can be manufactured cheaply. Such flat conveyor belts are replaced by a user by hand. A belt with a longitudinal profile has at least one stepped projection on which the belt end face is placed.

Preferably, the counter-barrier is normally moveable to the belt transport surface to vertically adjust a horizontal gap between the belt and the counter-barrier. This prevents unwanted clamping of the processed cable in the horizontal gap.

In addition, or as an alternative, the counter-barrier can be moved normally to the belt end face to horizontally adjust a vertical gap between the belt and the counter-barrier. This prevents unwanted clamping of the processed cable in the vertical gap.

The counter-barrier is preferably arranged in the inlet track section of the conveyor track so that it is arranged opposite the collection area on the cable stacker. Thus, the guidance of the cable is further improved. In particular, the counter-barrier extends along the conveyor track of the belt conveyor.

Preferably, an adjustment mechanism for moving the counter-barrier is arranged on the counter-barrier so that the counter-barrier is easily adjustable relative to the belt conveyor.

Alternatively, the counter-barrier is mechanically connected to an adjustment mechanism for moving the counter-barrier. The adjustment mechanism can have a spindle drive on which the first counter-barrier can be easily and continuously adjusted.

Preferably, this adjustment mechanism is designed in such a way that this adjustment mechanism is not adjustable during conveyor operation of the first belt conveyor. This prevents unwanted adjustment of the counter-barrier during operation. The adjustment mechanism can be self-locking for this purpose. Preferably, the adjustment mechanism comprises an oblong hole and a fastening device. For example, the adjustment mechanism is connected to the main frame of the cable stacker by means of at least one screw or bolt and with a washer in the area of this oblong hole. The washer is designed in such a way that the screw does not loosen in the event of vibrations, for example as a ribbed washer or as a wedge-locking washer (Nord-Lock). A plurality of screws or bolts, washers and oblong holes are provided for each adjustment mechanism. If the fastening device is slightly loosened by the user, then the adjustment mechanism and the counter-barrier attached to it can be moved freely. Once the screws or bolts are fixed, the counter-barrier relative to the main frame is fixed and uniquely positioned.

Alternatively, or in addition to this, the adjustment mechanism can, for example, have a spindle or a screw with a high inclination and/or have a fixing element, such as a lock nut for example. A counter-barrier with such an adjustment mechanism can also be easily adjusted even by an untrained user with simple tools, such as a torque spanner for example. Once the screws or bolts are fixed, the counter-barrier relative to the main frame is fixed and uniquely positioned.

Preferably, the adjustment mechanism comprises an adjustment aid so that the desired gap between the belt conveyor or the belt and the mating surface can be adjusted in a reproducible manner. The adjustment aid can be pushed into the gap using a motorized means or manually by the user. Subsequently, the counter-barrier is pushed towards the adjustment aid until the counter-barrier, adjustment aid and belt conveyor or belt each come into contact with each other. Before commissioning, the adjustment aid is pulled out of the gap or removed. This means that a reproducible gap of the optimum size for belts from different manufacturers can be created at any time and with little effort. In the event of heavy wear and tear of the belt (thickness reduction due to wear abrasion), the adjustment process can also be repeated a plurality of times on the same belt.

Preferably, the counter-barrier extends along the conveyor track of the first belt conveyor so that an improved guidance of a cable on the belt conveyor across a longer conveyor line is ensured.

A method according to the invention for adjusting a gap on a cable stacker, in particular on a cable stacker as described above, comprises at least the following steps:
a) arranging a belt on a belt conveyor,
b) transferring a counter-barrier from one first position to another position to set a gap between the belt and the counter-barrier.

The moveable counter-barrier makes it easy to adjust a gap between the belt and the counter-barrier when the belt is placed on the first belt conveyor, preventing unwanted clamping of the processed cable in this gap. This leads to a reduction in the number of incorrect placements in the cable stacker and to increased operational reliability.

Preferably, an adjustment aid is placed between the counter-barrier and the belt before step b). This means that a reproducible gap of the optimum size for belts from different manufacturers can be created at any time and with little effort. In the event of heavy wear and tear of the belt (thickness reduction due to wear abrasion), the adjustment process can also be repeated a plurality of times on the same belt.

Preferably, after step b), the adjustment aid between the counter-barrier and the belt is removed to prevent unwanted clamping of the processed cable with the adjustment aid.

Preferably, the further position of the counter-barrier depends on at least one cable parameter, in particular, the cable diameter. The cable parameters here are the cable type (coaxial cable, multi-guide element cable, etc.), the cable geometry (structure, dimensioning, cable length, etc.) as well as the overall structure of the processed cable, wherein the overall structure can also comprise a cable connector arranged on the cable.

In particular, the adjustment mechanism is connected to a control device for exchanging control data. Such an adjustment mechanism comprises a drive device with a drive for moving the counter-barrier, which drive can be controlled by the control device in a reproducible manner, for example, depending on the cable parameter.

In particular, a sensor device is available with which the gap between a conveyor' belt and the counter-barrier can be detected. For example, the sensor device comprises a distance sensor to detect the distance between the belt and the first counter-barrier and sends the sensor data to the control device. The control device comprises a computing unit and is connected to a database for the exchange of control data. The control data comprises control commands to control the drive device of the counter-barrier and/or control commands to control the conveyor rollers of the belt conveyor. The computing unit comprises a program that is suitable for evaluating the sensor data and calculating a gap width and comparing it with a reference value. If the gap width is too large for the cable to be processed, at least a warning is sent out and, where applicable, a conveyor operation of the belt conveyor is prevented or delayed. In particular, the sensor device is designed to measure the gap width directly. For example, the sensor device comprises an imaging sensor, such as a camera.

Further advantages, features and details of the invention result from the following description, in which exemplary embodiments of the invention are described with reference to the drawings.

The reference list, as well as the technical content of the patent claims and figures, is part of the disclosure. The figures and embodiments are described in a coherent and comprehensive matter. Identical reference numbers signify the same components; reference numbers with different indices indicate functionally identical or similar components. Enumerations, such as first, second, . . . others are only used to distinguish between components.

The figures show:

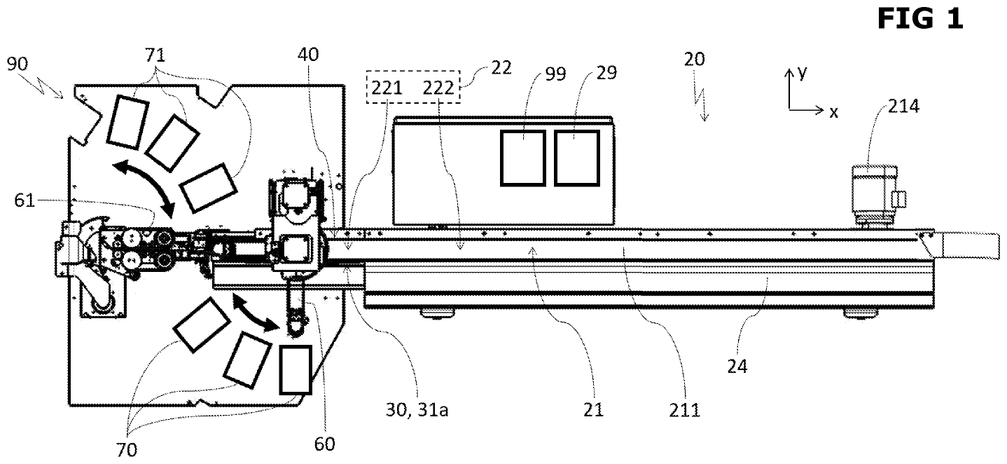

FIG. 1 a first embodiment of a cable-processing device with a cable stacker according to the invention in a schematic view (XY plane),

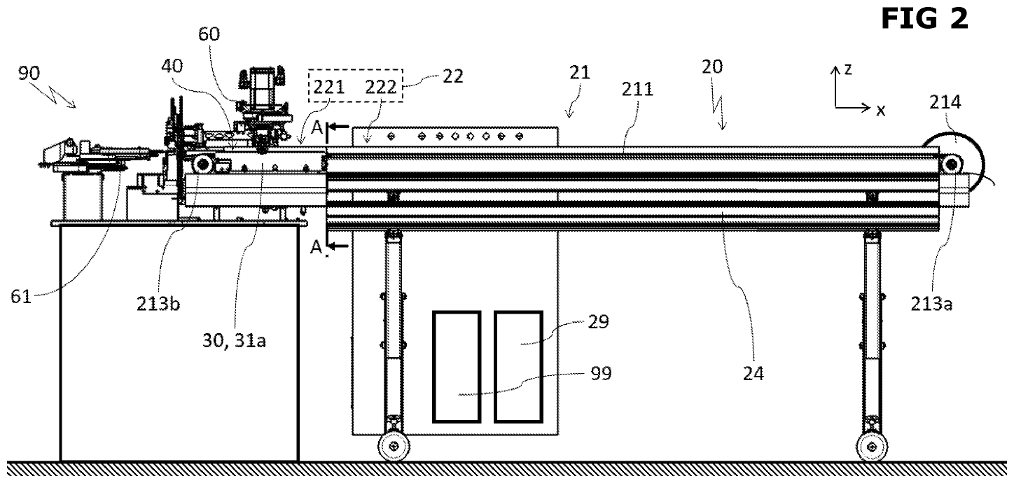

FIG. 2 cable-processing device in accordance with FIG. 1 in a schematic lateral view (XZ plane),

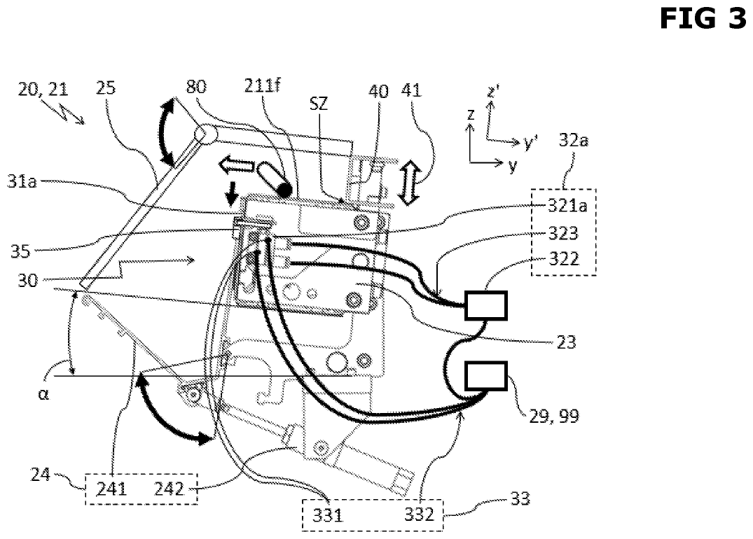

FIG. 3 the cable stacker in accordance with FIG. 2 in a sectional view, corresponding to the sectional plane (A-A) drawing in FIG. 2,

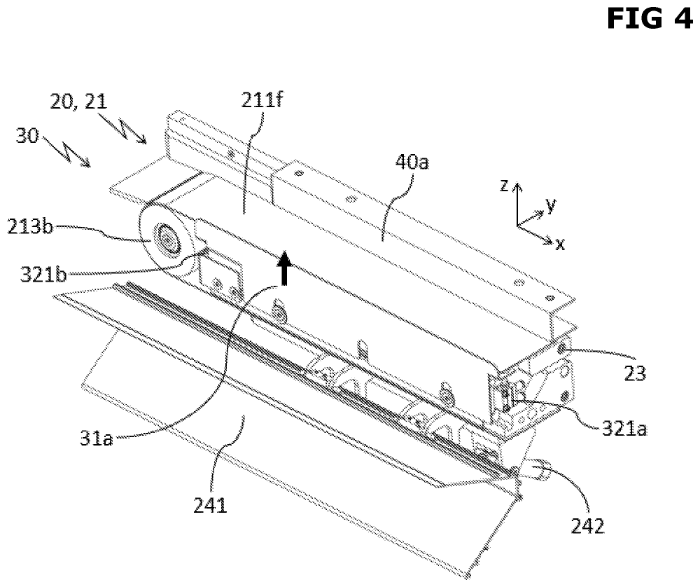

FIG. 4 the cable stacker in accordance with FIG. 3, as an isometric sectional view with a protective cover (not shown) and covered collection tub,

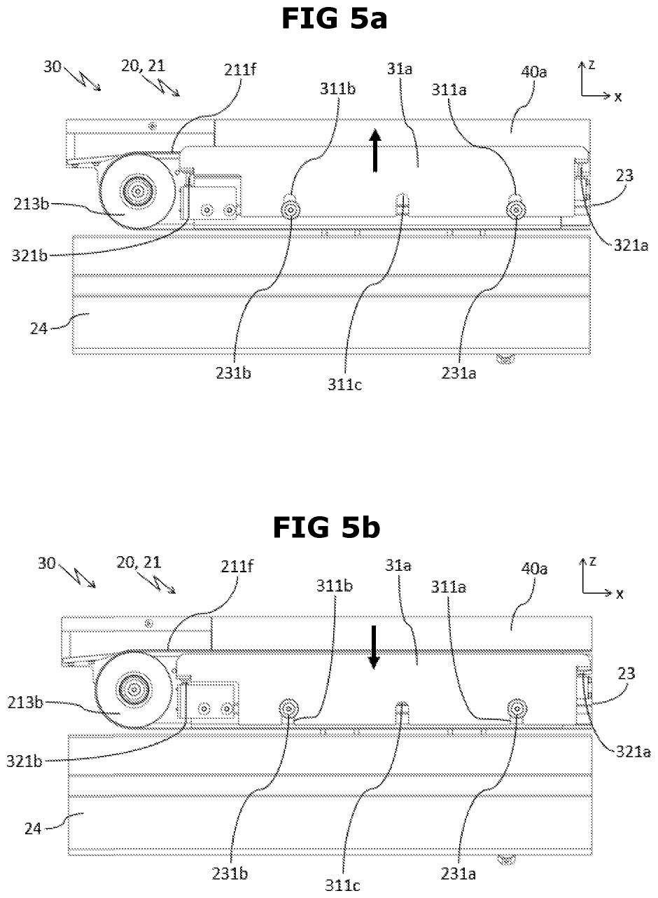

FIG. 5a the discharge barrier device of the cable stacker in accordance with FIG. 4 with the first discharge barrier in the active position in a lateral view,

FIG. 5b the discharge barrier device of the cable stacker in accordance with FIG. 4 with the first discharge barrier in the inactive position in a lateral view,

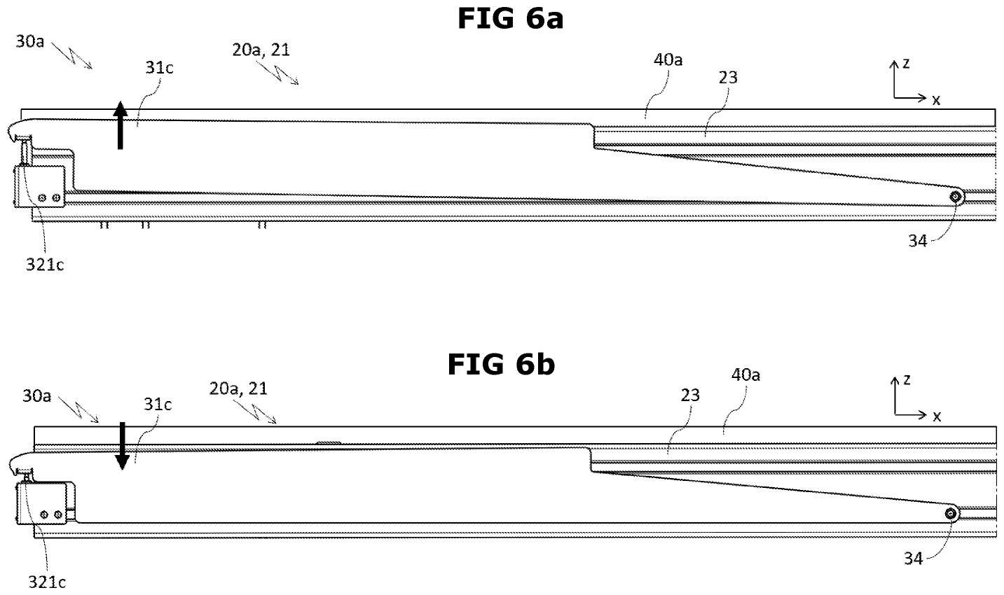

FIG. 6a an alternative embodiment of a discharge barrier for the cable stacker in accordance with FIG. 4 with the first discharge barrier in the active position in a lateral view,

FIG. 6b the discharge barrier device of the cable stacker in accordance with FIG. 6a with the first discharge barrier in the inactive position in a lateral view,

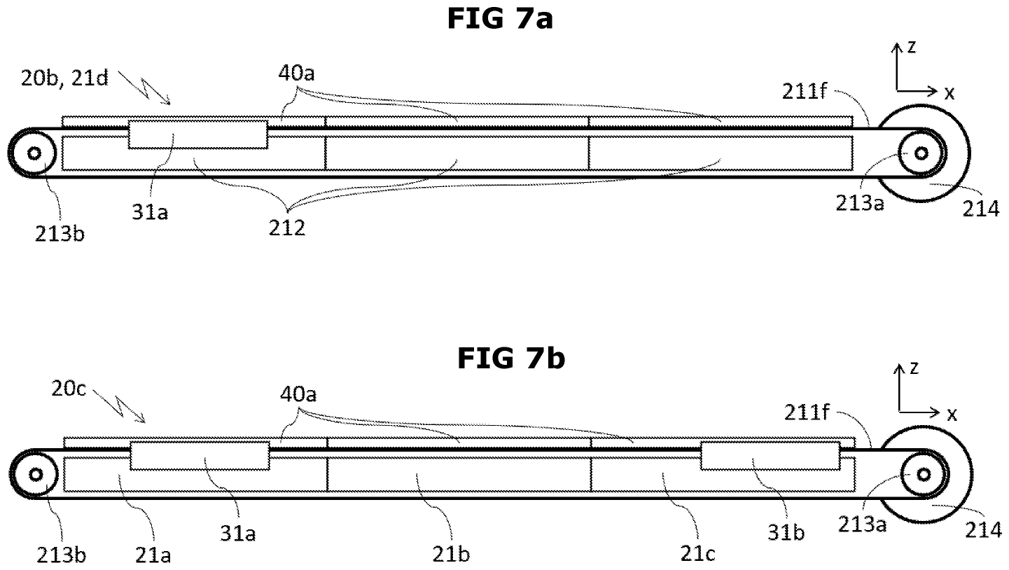

FIG. 7a an alternative embodiment of a cable stacker in accordance with FIG. 4 in a modular design in a lateral view

FIG. 7b another alternative embodiment of a cable stacker in accordance with FIG. 4 with a plurality of belt conveyors and a plurality of discharge barriers in a lateral view,

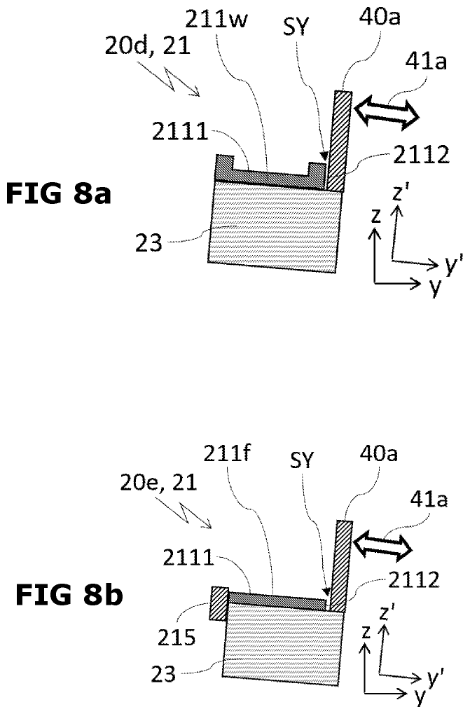

FIG. 8a an alternative embodiment of a cable stacker for a cable-processing device in accordance with FIG. 1 with a modified counter-barrier, with a belt with longitudinal profile, in a sectional view (Y-Z plane),

FIG. 8b an alternative embodiment of a cable stacker for a cable-processing device in accordance with FIG. 1 with a modified counter-barrier, with a flat conveyor belt, in a sectional view (Y-Z plane),

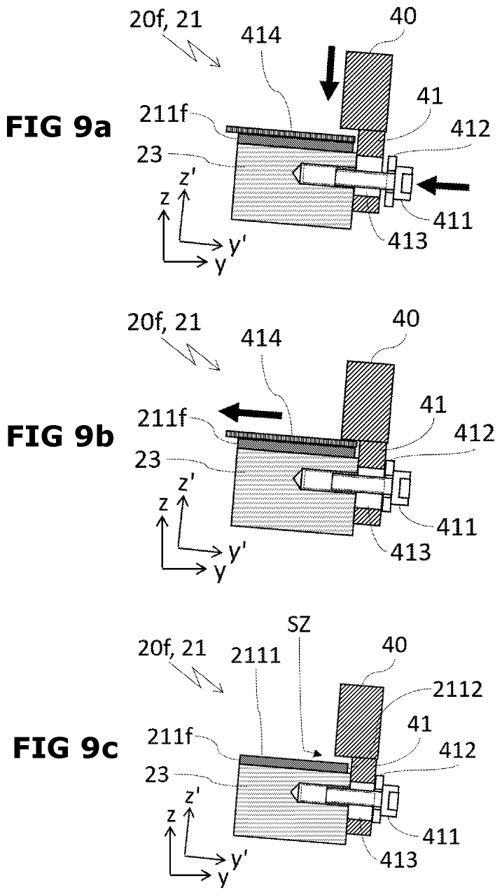

FIG. 9a an alternative embodiment of a cable stacker for a cable-processing device in accordance with FIG. 1 with the counter-barrier in a first position in a sectional view (Y-Z plane),

FIG. 9b the cable stacker in accordance with FIG. 9a, with the counter-barrier in a second position in a sectional view (Y-Z plane),

FIG. 9c the cable stacker in accordance with FIG. 9a with the counter-barrier in a third position in a sectional view (Y-Z plane),

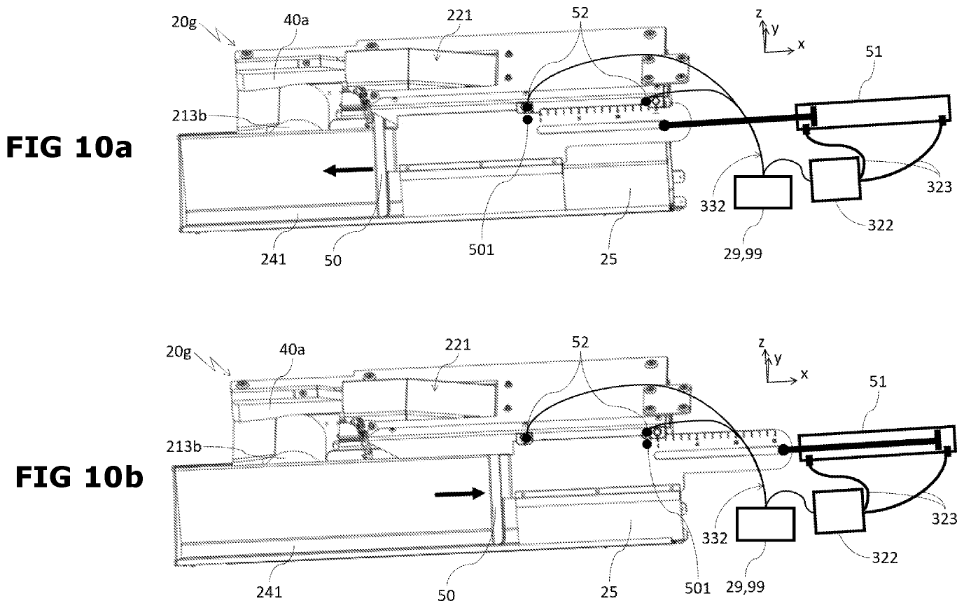

FIG. 10a an alternative embodiment of a cable stacker for a cable-processing device in accordance with FIG. 1, with an extended guide element in a first position in a sectional view (Y-Z plane),

FIG. 10b the cable stacker in accordance with FIG. 10a with the extended guide element in a second position in a sectional view (Y-Z plane),

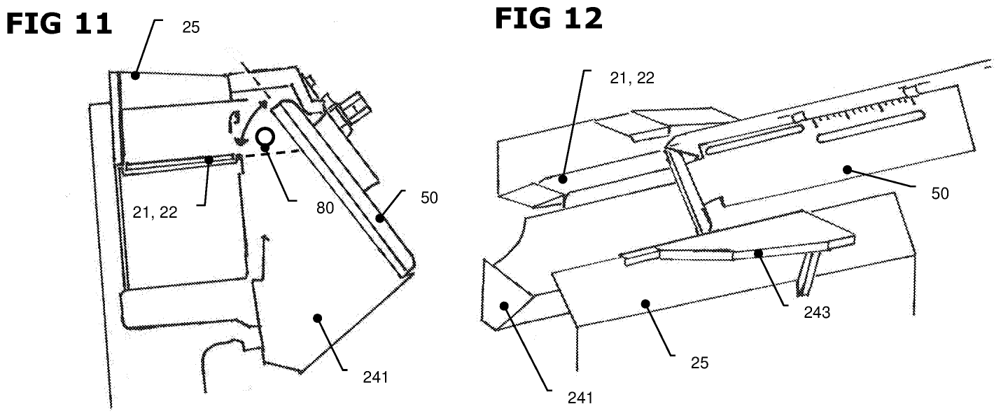

FIG. 11 the cable stacker in accordance with FIG. 10 viewed in a sectional view or lateral view in the conveying direction,

FIG. 12 an alternative embodiment of a cable stacker for a cable-processing device in accordance with FIG. 10 with a table-shaped repository plate, and

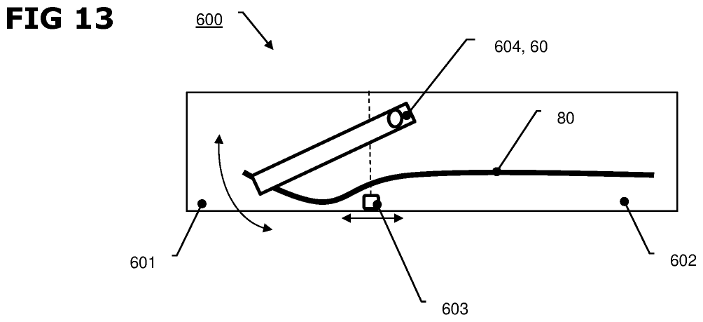

FIG. 13 a schematic illustration of a cable storage system of a cable-processing machine according to the invention. FIG. 1 and FIG. 2 show a first embodiment of a cable-processing device 90 with a cable stacker 20 according to the invention, in a view (XY plane, FIG. 1) and in a lateral view (XZ plane, FIG. 2). For a better view of the internal functional elements of the cable stacker 20, the protective cover 25 (visible in FIG. 3) is hidden. The cable-processing stations 70, 71 and the control devices 29, 99 are shown only schematically; hoses, control cables and other details incidental to the invention are also not shown.

The cable-processing device 90 is designed as a swivel arm machine and consists of two swivel arms 60, 61, which move or swivel the two ends of the cable 80 (not shown) to the respective cable-processing stations 70, 71. After processing in the cable-processing stations 70, 71, the cable 80 is transferred to the cable stacker 20. This consists of a first belt conveyor 21, which conveys the cable 80 along the conveying direction X. The first belt conveyor 21 comprises a belt 211, two matching conveyor rollers or pulleys 213a, 213b and a drive device 214 for active rotation of one of the two pulley 213a. The drive device 214 has an electric motor, for example with an integrated gearbox, as a drive. The conveyor track 22 of the cable stacker 20 comprises an inlet track section 221 and an outlet track section 222. In the inlet track section 221, the cable 80 is dropped by the discharge device 60, wherein, in this embodiment, a swivel arm of the cable-processing device 90 performs the function of this discharge device 60.

Alternatively, the discharge device 60 can also be a stand-alone assembly, which is arranged on the cable stacker 20. This is useful and necessary for alternative cable-processing devices (not shown), designed for example as a transfer or rotary transfer machine for example.

The dropped cables 80 fall into the collection area 24, which typically comprises a tiltable collection tub 241 (FIG. 3).

In order to prevent cable 80 from falling unintentionally and/or prematurely from the first belt conveyor 21, a discharge barrier device 30 with a first discharge barrier 31a and with a first counter-barrier 40 is provided, at least in the inlet area 221. The first discharge barrier 31a is used to prevent uncontrolled sliding of cable 80 off the conveyor track 22, wherein the first discharge barrier 31a is moveable relative to the counter-barrier 40a. The discharge barrier device 30 is located in the area of the pulley 213b, which moves passively with the belt 211.

To control all sensors and drive elements of the cable stacker 20, they are electrically connected to a control device 29. This control device 29 is part of the cable stacker 20 and is, in turn, connected to a central control system 99 of the cable-processing device 90.

Alternatively, the local control device 29 in the cable stacker 20 can be dispensed with. For this purpose, the control cables of all sensors and drive elements of the cable stacker 20 are directly electrically connected to the central control system 99 of the cable-processing device 90.

FIG. 3 shows the cable stacker 20 from FIG. 2 in a sectional view along the sectional plane (A-A) with the processed cable 80 and a protective cover 25, wherein the first discharge barrier 31a is in the inactive position or passive position (below) and the collection tub 241 is shown folded up so that a discarded cable 80 can be stored in the collection tub 241. FIG. 4 shows the cable stacker 20 in an isometric sectional view wherein the protective cover 25 and the cable 80 are not shown but with the first discharge barrier 31a in the active position (top) and the collection tub 241 folded down.

The first discharge barrier 31a is moved by a drive device 32a. This drive device 32a consists of two pneumatic cylinders 321a, 321b (only visible in FIG. 4), which are connected to a valve battery 322 via hoses 323 (schematically shown in FIG. 3). This valve battery 322 is in turn electrically connected to the control device 29, 99 by means of the control cables 332. In order to reliably detect the two end positions of the pneumatic cylinders 321a, 321b, therefore detecting that the active and inactive positions of the discharge barrier 31a have been reached, there is a sensor device 33. This typically consists of two sensors 331 for each pneumatic cylinder 321a (schematically shown in FIG. 3) and the associated control cables 332, which also electrically connect the sensors 331 to the control device 29, 99. These sensors 331 are designed as magnetic proximity switches and are fixed in the grooves provided for this purpose on the pneumatic cylinders 321a, 321b. In order to save costs, alternatively, only one sensor 331 per pneumatic cylinder 321a, 321b can also be used, which detects either the active or the inactive position of the discharge barrier 31a.

In order to prevent the cable 80 from falling off the belt conveyor 21 in an unwanted way, it is tilted in relation to the main frame 23 and the horizontal Y by the tilt angle α, which is 6° here. The tilted coordinate system is indicated by the letters Y′ and Z′ and tilted with respect to the normal coordinate system Y, Z (horizontal, vertical) around the X-axis with the tilt angle.

In order to also prevent the cable 80 from falling on the opposite side as well, the counter-barrier 40 is used. The belt 211, which is designed as a flat conveyor belt 211f, overlaps the counter-barrier 40 in its width direction Y′ and the gap SZ between flat conveyor belt 211f and counter-barrier 40 is in the Z′ direction. As a result, a lateral guide of the flat conveyor belt 211f can be dispensed with (as in FIG. 8b) and the width of the flat conveyor belt 211f does not have to be tolerated particularly precisely. Also, a simple and inexpensive flat conveyor belt 211f can be used instead of an expensive belt with longitudinal profile 211w (as shown in FIG. 8a). In order to set the gap SZ as small as possible and thus prevent the cables 80 from jamming in this gap SZ, the counter-barrier 40 can be adjusted precisely, easily and in a reproducible manner via an adjustment mechanism 41 (schematically shown as a block arrow, details in FIG. 9a and FIG. 9b) normally to the flat conveyor belt 211f (i.e., in the Z′ direction). Thus, flat conveyor belts 211f can be used in different thicknesses, which enables a favourable procurement of these flat conveyor belts 211f. Also, the replacement of a only partially worn flat conveyor belt 211f (with reduced thickness due to signs of abrasion) can be delayed a little further by adjusting the gap SZ using the adjustment mechanism 41.

In an alternative embodiment of the cable stacker (FIG. 9a, FIG. 9b), the counter-barrier 40 described here with the associated adjustment mechanism 41 can also be used without the combination with a discharge barrier 31 or discharge barrier device 30.

In particular, the flat conveyor belt 211f has a special surface finish, which enables a particularly high coefficient of friction to the cable 80 in conveying direction X. Furthermore, the surface finish of the flat conveyor belt 211f is designed in such a way that, on the one hand, wear and tear is kept as low as possible and thus enables a long service life, and on the other hand, for contact to be made with cable 80 as gently as possible so as not to cause any damage there.

The cables 80 are moved in the direction of the collection area 24 (block arrow) when they are dropped and then fall into the collection area 24, in which the tilting collection tub 241 is arranged. The tilting is carried out by means of a drive 242, here designed as a pneumatic cylinder, and again connected to the valve battery 322 and the control device 29, 99 by means of hoses, sensors and control cables (not shown). Underneath the tilting collection tub 241 there is typically another tray (not shown) for the user to remove the cables.

The tilting collection tub 241 comprises a fixing device 35. The fixing device 35 fixes the first discharge barrier 31a in its inactive position.

Alternatively (not shown), such a fixing device can also be designed in such a way that it fixes the first discharge barrier 31a in the active position (above). In an extended embodiment (not shown), the fixing device can also be designed in such a way that the movement of the collection tub 241 is mechanically coupled to the movement of the discharge barrier 31a and therefore, only one drive is necessary for both movements, i.e., the drive device 32a can be omitted and/or replaced by a simple, passive force element (e.g., a spring).

In order to improve safety for the user and to prevent the cable 80 from being shot out beyond the collection area 24, a protective cover 25 is provided (schematically shown). The protective cover 25 typically comprises transparent areas to allow the user to visually view the process even when closed and can be folded up for service purposes. For this purpose, the protective cover 25 is equipped with the aid of a hinge and with a snap-in and/or spring mechanism with integrated damper elements (e.g., gas-pressure springs, not shown), which fixes the uncovered position and/or reduces the effort required when uncovering or distributes it more evenly over the overall movement. Preferably, the protective cover 25 is connected to the main frame 23. In order to further improve the storage quality, a guide element 50 is preferably integrated in this protective cover 25 (FIG. 9).

FIG. 5a and FIG. 5b show the elements of the cable stacker 20 to the left of the sectional plane A-A (FIG. 2), i.e., as shown in FIGS. 3 and 4, in a detailed lateral view (XZ plane). In both figures, the processed cable 80 and the protective cover 25 are not shown and the collection tub 241 is folded down (as in FIG. 3). In FIG. 5a, the first discharge barrier 31a is in the active position (above); and in FIG. 5b, the first discharge barrier 31a is in the inactive position (below, FIG. 5b). The first discharge barrier 31a is a long plate, which can be moved from the active position to an inactive position orthogonally to the conveying direction X (represented by thick arrows in the Z direction). At the first discharge barrier 31a, the pneumatic cylinders 321a, 321b are arranged at the two opposite ends, which are connected to the main frame 23 and move the entire first discharge barrier 31a evenly. At the first discharge barrier 31a, guide grooves 311a, 311b, 311c are arranged, through which guide attachments 231a, 231b extend.

The method for the safe transport of a cable 80 on the cable stacker is illustrated using the example of the cable stacker 20 in accordance with FIG. 1 to 5b comprises at least the following steps:
a) selecting at least one cable parameter, which is retrieved from a database.
b) transferring the first discharge barrier 31a relative to a counter-barrier 40 into an active position;
c) conveying the cable 80 on the first belt conveyor 21.

The control device 29 or the central control system 99 are connected to the database for the exchange of cable parameters so that cable parameters that have already been stored can be accessed.

After step c), at least one cable-processing tool of a cable-processing station 70 is activated for the trailing cable end 80.

After conveying the cable on the first belt conveyor 21 (step c)), the step of transferring the first discharge barrier (31a) to an inactive position (step d, FIG. 5b) and subsequently, or after completion of all processing of the trailing cable end, the discharge of the cable 80 with the discharge device 60, preferably integrated in the swivel arm for the cable-processing stations 70 of the trailing cable end (step e)). This means that the cable is reliably discarded without getting caught on the discharge barrier.

The transfer of the first discharge barrier (31a) to an inactive position (step d, FIG. 5b) is carried out before the processing of the trailing cable end 80 in the cable-processing stations 70 provided for this purpose (FIG. 1). Steps a) and b) are preferably carried out in parallel or at the same time as the processing of the leading cable end 80 in the cable-processing stations 71 provided for this purpose (FIG. 1). By executing the steps in parallel, cycle time is saved.

FIG. 6a and FIG. 6b show an alternative embodiment of a cable stacker 20a with an alternative discharge barrier device 30a, in a detailed lateral view (XZ plane), and again shown once with the discharge barrier 31c in the active position (top, FIG. 6a) and once in the inactive position (bottom, FIG. 6b). The collection tub is not shown.

The alternative drive device 32b for the alternative discharge barrier device 30a comprises a single pneumatic cylinder 321c, which moves the alternative discharge barrier 31c on one side. On the other hand, the alternative discharge barrier 31c is rotatably mounted, for example with a plain bearing 34. In order to prevent overdetermination and thus to keep the movement smooth, some play in the X direction is provided in the area of the plain bearing 34, for example through an oblong hole (not shown) in the discharge barrier 31c. Furthermore, the attachment of the discharge barrier 31c to the pneumatic cylinder 321c is designed in such a way that small rotations around the Y′ axis are possible, by elastic construction or by using an additional swivel joint (not shown).

FIG. 7a and FIG. 7b show two further alternative embodiments of a cable stacker 20b, 20c in a schematic lateral view (XZ plane), here constructed in a modular design, once with a plurality of modular frames 212 in a single belt conveyor 21d (cable stacker 20b, FIG. 7a) and once with a plurality of belt conveyors 21a, 21b, 21c and a plurality of discharge barriers 31a, 31b (cable stacker 20c, FIG. 7b).

The alternative cable stacker 20b in accordance with FIG. 7a consists of only a single belt conveyor 21d. The structure of this 21d belt conveyor is modular with three 212 modular frames. This belt conveyor 21d contains only a single flat conveyor belt 211f, with only a single drive device 214 and two pulleys 213a, 214b and an associated tensioning system for tensioning the flat conveyor belt (not shown). The counter-barriers 40a are also modular, in the same lengths as the respective modular frames 212.

The alternative cable stacker 20c in accordance with FIG. 7b consists of three belt conveyors 21a, 21b, 21c. All these belt conveyors 21a, 21b, 21c use the same flat conveyor belt 211f, with only a single drive device 214 and two pulleys 213a, 214b and an associated tensioning system for tensioning the flat conveyor belt (not shown). The 40a counter-barriers are also modular, in the same lengths as the respective belt conveyors 21a, 21b, 21c. In addition, a second discharge barrier 31b is provided for the cable stacker 20c, with an associated drive and sensor device (not shown), which structurally and functionally corresponds to the first discharge barrier 31a.

In both embodiments described above, it is also possible to arrange 15 two or more than two modules side by side to extend the length of the conveyor track.

FIG. 8a and FIG. 8b show two further alternative embodiments of a cable stacker 20d, 20e, which are essentially functionally and structurally similar to the cable stackers 20 described above in accordance with FIG. 1b is FIG. 5b, wherein there is an alternatively designed counter-barrier 41a. FIG. 8a shows the cable stacker 20d with a belt with longitudinal profile 211w and FIG. 8b shows the cable stacker 20e with a flat conveyor belt 211f and a lateral guide 215. Both cable stackers are only schematically shown in a sectional view in the YZ plane. This embodiment can at least also be used in combination with the alternatives for the discharge barrier (FIG. 6a and FIG. 6b) and/or in combination with the variants for the modular design (FIG. 7a and FIG. 7b).

In the case of the cable stacker 20d shown in FIG. 8a, in contrast to the embodiment of the cable stacker 20 with flat conveyor belt 211f (FIG. 3), a belt with longitudinal profile 211w is used. The previously common embodiment (state of the art) is now supplemented with a moveable counter-barrier 40a. This belt with longitudinal profile 211w is spaced away from the counter-barrier 40a in the Y′ direction, or the gap SV is formed there. Compared to flat conveyor belts 211f, such belts with longitudinal profile 211w are much more expensive, more difficult to obtain from only a few manufacturers, more complex to assemble and wear out faster.

The cable stacker 20e shown in FIG. 8b represents the embodiment in which the belt with longitudinal profile 211w is replaced by a flat conveyor belt 211f, but the counter-barrier 40a is still designed in the same way as in the alternative cable stacker 20d from FIG. 8a. Here, too, the gap SY forms in the Y′ direction, in which the cable 80 (not shown) can now jam due to the longitudinal profile that no longer exists—which would lead to interference. To improve this problem, a lateral guide 215 is provided.

An adjustment mechanism 41a for the counter-barrier 40a is arranged on the two other embodiments of the cable stacker 20d (FIG. 8a) and the cable stacker 20e (FIG. 8b). This alternative adjustment mechanism 41a differs from the adjustment mechanism 41 of the embodiment of the cable stacker 20 in accordance with FIG. 3 that it allows a displacement of the counter-barrier 40a in the Y′ direction and thus creates a gap SY between the belt end face 2112 and the counter-barrier 40a, whereas the adjustment mechanism 41 in the embodiment of the cable stacker 20 allows a displacement of the counter-barrier 40 in the Z′ direction, thereby creating a gap SZ between the belt transport surface 2111 and the counter-barrier 40.

FIG. 9a bis Fig. FIG. 9c shows a further embodiment of a cable stacker 20f, which does not comprise a discharge barrier but comprises substantially the same functional and structural elements as the cable stacker in accordance with FIG. 1 to 5b, in a sectional view in the YZ plane, with the sectional plane defined by the position of a screw 411 of the adjustment mechanism 41. Furthermore, the elements of the adjustment mechanism 41 as well as the method for setting the desired gap SZ are shown.

The main body of the adjustment mechanism 41 is connected to the counter-barrier 40 and comprises at least one oblong hole 413, which allows adjustment/displacement in the Z′ direction. Using at least one screw 411 and a washer 412 as a fastening device, the adjustment mechanism 41 in the area of this oblong hole 413 is connected to the main frame 23 of the cable stacker 20f. The washer 412 is designed in such a way that the screw 411 does not loosen in the event of vibrations, for example as a ribbed washer or as a wedge-locking washer (Nord-Lock). A plurality of screws 411, washers 412 and oblong holes 413 are provided for each adjustment mechanism 41 (only one is visible in each section view). If all screws 411 are slightly loosened by the user (FIG. 9a), then the adjustment mechanism 41 and the counter-barrier 40 attached to it are freely moveable in the Z′ direction, for example, by a user. Once the screws 411 are tightened (FIG. 9a, FIG. 9b), the counter-barrier 40 relative to the main frame 23 and the rest of the elements of the cable stacker 20f is fixed and uniquely positioned.

In order to adjust the desired gap SZ between the belt transport surface 2111 of the flat conveyor belt 211f and the mating surface 40, the adjustment mechanism 41 comprises an adjustment aid 414. For this purpose, all screws 411 are first loosened slightly and the adjustment mechanism 41 with the counter-barrier 40 is shifted so that the gap between the flat conveyor belt 211f and the counter-barrier 40 reaches a maximum level. The adjustment aid 414 is pushed into this gap (FIG. 9a), preferably by hand by the user. Subsequently, the counter-barrier 40 is pushed again in the opposing direction (arrow in the Z′ direction) until it stops, i.e., until the counter-barrier 40, adjustment aid 414 and flat conveyor belt 211f each come into contact with each other. Subsequently, all screws 411 are tightened again (arrow in Y′ direction).

The position with the adjustment aid 414 still in position but the screws 411 already tightened is shown in FIG. 9b. Before commissioning, the adjustment aid 414 is now pulled out or removed (arrow in Y′ direction).

The position with the remote adjustment aid 414 is shown in FIG. 9c. The gap SZ is formed between the belt transport surface 2111 of the flat conveyor belt 211f and the counter-barrier 40. This corresponds approximately to the thickness of the adjustment aid 414 and is independent of the thickness of the flat conveyor belt 211f. This means that a reproducible gap SZ in an optimal size for flat conveyor belts 211f from different manufacturers can be created at any time and with little effort. If the flat conveyor belt 211f is worn heavily (thickness reduction due to wear/abrasion), the adjustment process can also be repeated a plurality of times with the same flat conveyor belt 211f.

In a further, alternative embodiment of a cable stacker described above, there is additionally a sensor device, using which the gap between a belt and the counter-barrier can be detected (not shown). The sensor device comprises a distance sensor to detect the distance between the belt and the first counter-barrier and sends the sensor data to the control device. The control device comprises a computing unit and is connected to a database for the exchange of control data. The control data comprises control commands to control the drive device of the counter-barrier and/or control commands to control the conveyor rollers of the belt conveyor. The computing unit comprises a program that is suitable for evaluating the sensor data and calculating a gap width and comparing it with a reference value. For example, the sensor device comprises an imaging sensor, such as a camera.

FIG. 10 (a-b) shows another embodiment of a cable stacker 20g with an actively moveable guide element 50, which is arranged on the protective cover 25. This guide element 50 is designed here as a sliding plate and is used to improve the guidance of cable 80 in the inlet track section 221 when dropping the cable (not shown), thereby ensuring optimum storage quality. The optimal position of this guide element 50 depends on cable parameters such as cable length, cable thickness, cable stiffness. Therefore, the guide element 50 is designed in such a way that it can be moved in the X direction (represented by the thick arrow). In FIG. 10a, the guide element 50 is shown in the first position, where the first guide element is positioned close to the first pulley 213b and in FIG. 10b, it is shown in the other position, where it is positioned further away further away from at the first pulley 213b. The first position is favourable for a short cable, and the other more distant position is favourable for a long cable. Short and long is defined relative to the radius of the swivel arm of the discharge device 60: a cable length less than 3× the swivel arm radius, preferably less than 2.5×, being furthermore preferred, less than 1.5×, is defined as “short”, larger than “long”. The swivel arm radius is typically in the range of 300-400 mm. These dimensions apply to typical universal cable stackers. For special cases, however, the dimensions can also differ, e.g., for particularly thin cables, lines or wires.

After the final processing of the trailing cable end in one of the cable-processing stations 70, the swivel arm of the discharge device 60 moves to the discharge position (approximately 10°-20° obliquely to the longitudinal axis of the conveyor track 22). This (and earlier) swivel movement, which is often violent due to high speed, results in a meandering movement in cable 80, which, depending on the cable parameters, can lay the leading cable end, for example, outside the collection area 24. This problem is more serious with shorter cables, shorter cycle times, or higher conveying speeds (e.g., 12 m/s) of the cable stacker 20. Favourably, the guide element 50 dampens the meandering movement of longer cables and thus ensures an increased storage quality of the cables 80 that is to be put down The inclined position of the guide element 50 results not only in damping but also in a force effect on the cable from top to bottom in the direction of storage. In the case of short cables or wires, it is not so much a matter of dampening a lateral movement as of preventing a cable piece or the leading cable end from swerving laterally beyond the collection tub. Therefore, the guide element is particularly important, particularly for short cables.

In the embodiment of FIGS. 10a and 10b, the sliding plate is bent by approx. 80° and ends in a finger-shaped beam, which is positioned as a guide element 50 on the side of conveyor track 22 (see cross-sectional view in FIG. 11). Preferably, the beam projects over the conveyor track 22 to at least the working height of the discharge device 60 above the conveyor track 22 in order to dampen the lateral meandering movement of the cable 80.

On the plane of conveyor track 22, the distance between the beam and the conveyor track is preferably between 20 and 50 mm, preferably between 30 and 40 mm. Favourably, the spaced-away guide element 50 allows the cable 80 to bend, which favours the sliding of the cable from the conveyor track 22 into the collection tub 241.

As shown in FIG. 11, the guide element 50 preferably forms an angle β of less than 90° (for example, 50°-80°, preferably 55°-75°, in particular 57°) to the top side of the belt conveyor. Furthermore, the beam can form an angle of preferably 20°-30° on the plane of the sliding plate (not shown in FIG. 11). Such angles favour the sliding of the cable off the conveyor track 22 into the collection tub 241. The conveying speed of the belt conveyor 21 is preferably set about 10% faster than the feed speed of the cable 80 from the processing machine. This results in a permanent friction-induced pull on the cable as long as it is held in place by the gripper of the discharge device 60. Since the cable 80 bends around the guide element—with the discharge device 60 in a discharge position (10°-20° to the conveying direction)—this exerts a force on the cable. Due to the inclination of the guide element 50, a force component on the cable 80 acts downwards in the direction of dropping. Therefore, the cable tries to pull itself down from the belt conveyor in the direction of dropping. Favourably, according to the invention, this embodiment does not require any lateral tilting/displacement of a cable on the belt conveyor as long as the belt conveyor is conveying, and the cable is held in the gripper and bends around the guide element 50.

Preferably, the side of the guide element facing the conveyor track 22 has a rounded shape. Favourably, this prevents the cable from being damaged or material-stressed during the dampening of the meandering movement.

In order for the user to ensure that the cables are properly put down and that he/she does not forget the displacement depending on the cable parameters, it is favourable to detect the position of the guide element 50 or a detection element 501 (e.g., a magnet) arranged on it by means of a sensor device 52 and/or to actively drive the movement of the guide element 50 by means of a drive device 51, both electrically connected to the control device 29, 99 of the cable stacker 20 or the cable-processing device 90. Alternatively, the detection element can be integrated in the drive device, preferably in the cylinder piston of the pneumatic cylinder.

In a supplementary embodiment (not shown), this drive device 51 is designed as an electric drive axle and the sensor device 52 as a rotary encoder or absolute encoder. Thus, the position of the guide element 50 can be actively adjusted, and indeed continuously or with any number of positions.

In another embodiment (not shown), a drive device is dispensed with, and the sensor device consists of at least one binary sensor, for a position of the first guide element. If this position does not match the current processed cable length, the cable stacker or its drive devices or the cable-processing device or its drive devices stops and informs the user that the guide element must be moved to the correct position.

In an extended embodiment (not shown), a plurality of sensors are installed or an absolute encoder, wherein a drive device can still be dispensed with.

In den FIG. 10a or 10b, respectively, an embodiment is schematically drawn, which can approach two positions, which is actively driveable. The drive device 51 is designed as pneumatic cylinders, which are connected via hoses 323 to the same valve battery 322 as most other pneumatic cylinders of this cable stacker 20g. The sensor device 52 consists of two binary sensors or limit switches, which are arranged in such a way that they send a signal at the respective end positions. Shown here is an arrangement in the area of the guide element 50.

Alternatively, the sensor device 52 can also be integrated in the area of the pneumatic cylinder, as shown in FIG. 3 for the 20 drive device 32a. In addition, the valve battery 322 and the sensor device 52 are electrically connected to the control device 29, 99 (not shown) via the control cable 332.

As an alternative to the integration of the guide element 50 into the protective cover 25, it can also be attached to another element of the cable stacker. It is also possible to use a plurality of guide elements per cable stacker.

The method for the safe transport of a cable 80 on the cable stacker is illustrated using the example of the cable stacker 20g in accordance with FIGS. 10a and 10b shall include at least the following steps:
a) transferring the first guide element 50 to a first position, wherein the first position is matched to the length of the cable 80 to be carried;
b) checking the first position of the first guide element 50 using the sensor device 52;
c) transferring of control data to the control device 29, 99;
d) conveying the cable on the first belt conveyor.

Prior to step a), at least one cable parameter of the cable can be selected, for example from a database stored in the control device 29, 99. The control device 29 or the central control system 99 are connected to the database for the exchange of cable parameters. The transfer of the first guide element 50 to the first position (step a) is carried out by means of the drive device 51.

A further embodiment of the invention comprises an additional, table-shaped repository plate 243, which can optionally be attached to the edge of the collection tub 241 and projects approximately horizontally from it in order to prevent skipping of the free collection area in the collection tub 241 in the case of particularly short cables 80 and wires 80 that is to be put down Where applicable, short cables can also be placed directly on the repository plate 243 and then fall inwards from there into the collection tub 241.

A cable stacker 20 according to the invention comprises a belt conveyor 21 for conveying a cable 80 along a conveying direction (X) and a discharge device 60 for dropping the cable into a collection tub 241 on the side of the belt conveyor, wherein the discharge device is rotatably arranged around an axis aligned transversely to the conveying direction approximately perpendicularly aligned with the belt conveyor, and the axis is positioned above the belt conveyor (See FIG. 1). In the area of the collection tub, a guide element 50 is arranged, which can be positioned longitudinally along the conveying direction X. The positioning range of the guide element extends from a first position in the conveying direction in front of the axis to a second position in the conveying direction after the axis.

In one embodiment, the discharge device comprises a swivel arm having a radius, and the positioning area of the guide element is at least 40%, preferably at least 50% of the radius.

In a further embodiment, the positioning area of the guide element extends ⅔ in front of the axis and ⅓ behind the axis in the cable-conveying direction (X).

In a further embodiment, the second position is so far behind the axis that the angle formed by the discharge device or the gripper by the discharge device 80 when the discharge device 60 rotates 1200 (in the direction of a cable-processing station 70) is at least 90°, preferably at least 100°. The favourable effect of this is that, in the case of a long cable, the cable 80 is not pulled out of the belt conveyor 21 by the rotation of the discharge device 60 around the guide element 50 and that loops are formed which prevent or make it difficult to put down the cables.

A cable storage system according to the invention 600 (see FIG. 13) of a cable-processing machine comprises a swivelling gripper arm 604 for holding, guiding and dropping a cable (discharge device 60) in a working space 601 which is adjacent to a storage space 602 in the direction of cable feed, wherein the cable storage system has a boundary edge 603 which separates the working space from the storage space. The boundary edge serves as an inlet guide for guidance a cable 80 to be deposited in storage space 602. The boundary edge 603, or the inlet guide, is arranged in a moveable manner. In this way, it makes the spatial relationship between the working space and the storage space relative.

In one embodiment of the cable storage system 600, the storage space 602 comprises two side boundaries (aligned with each other) between which the cable 80 is guided in the direction of cable feed in the operating state. The first side boundary is arranged in a non-moveable manner and extends into the working space 601. The second side boundary comprises the boundary edge 603 and is arranged in a moveable manner.

In one embodiment of the cable storage system 600, the working space 601 and storage space 602 are arranged horizontally adjacent, and the boundary edge 603 or the inlet guide is inclined obliquely to the plumb line, preferably at an angle of 50°-80°, being furthermore preferred, 55°-75°, in particular, 57°.

In one embodiment of the cable system 600, all boundary edges 603 of the storage space 602 or the entire storage space relative to the working space 601 are displaced depending on the cable parameters of the cables 80 that is to be put down.

### REFERENCE LIST

20, 20a-g cable stacker
21, 21a-d belt conveyor
211 belt
211f flat conveyor belt
2111 belt transport surface
2112 belt end face
211w belt with longitudinal profile (belt bead)
212 modular frame
213, 213a-b pulley (conveyor roller)
214 drive device (electric motor)
215 lateral guide
22 conveyor track
221 inlet track section
222 outlet track section
23 (main) frame
231, 231a-b guide attachments
24 collection area
241 collection tub (tilting tub)
242 drive (for 241)
243 repository plate
25 protective cover
29 control device
30, 30a discharge barrier device
31 discharge barriers
31a-c discharge barriers
311, 311a-c guide grooves
32, 32a-b drive device
321, 321a-c pneumatic cylinders
322 valve (battery)
323 hose/hoses
33 sensor device
331 sensor(s) (for 31)
332 control cable
34 plain bearings
35 fixing device
40,40a counter-barrier
41, 41a adjustment mechanism
411 screw
412 washer
413 oblong hole
414 adjustment aid
50 (first) guide element (guide plate)
501 detection element (detection area)
51 drive device (for 50)
52 sensor device (for 50)
60 discharge device (swivel arm)
600 cable storage system
601 working space
602 storage space
603 boundary edge
604 swivelling gripper arm
61 main swivel (swivel arm)
70 cable-processing station(s)
71 cable-processing station(s)
80 (processed) cable or wire, line, fibre-optic cable or the like
90 cable-processing device
99 central control system
A sectional plane
α tilt (angle)
β first guide element angle
SY, SZ gap
X (conveyor) direction for 80
Y direction (horizontal, transverse to X)
Y′ direction (parallel to the belt, transverse to X)
Z direction (vertical)
Z′ direction (orthogonal to the belt, transverse to X)

1-21. (canceled)

22. A cable stacker (20) with a first belt conveyor (21a) for conveying a cable (80) along a conveying direction (X), wherein the first belt conveyor (21a) is suitable for accommodating a belt (211) and there is a main frame (23) on which the first belt conveyor (21a) is arranged, and a discharge device (60) is provided for dropping a cable (80) into a collection tub (241),
wherein
in an area of the collection tub (241) on a side of the first belt conveyor (21a), a first guide element (50) is arranged to dampen a meandering movement of a cable that is to be put down, wherein the first guide element (50) is positional longitudinally along the conveying direction (X).

23. The cable stacker (20) according to claim 22, wherein a sensor device (52) with at least one sensor for determining a first position of the first guide element (50), wherein the sensor device (52) is electrically connected to a control device (29, 99) or to a central control system (99) of a cable-processing device (90), and/or a drive device (51) for the movement of the first guide element (50) is connected to the first guide element (50).

24. The cable stacker (20) according to claim 23, wherein the drive device (51) for the movement of the first guide element (50) is electrically connected to the control device (29, 99), or is electrically connected to the central control system (99) of a cable-processing device (90).

25. The cable stacker (20) according to claim 23, further comprising a protective cover (25), and the first guide element (50) is arranged on the protective cover (25), wherein the protective cover (25) is, in particular, moveable, preferably tiltable, and contains fixing, damper and/or spring elements.

26. The cable stacker (20) according to claim 22, wherein the first guide element (50) is arranged transversely to the conveying direction (X) and obliquely to the perpendicular.

27. The cable stacker (20) according to claim 26, wherein the first guide element (50) forms an angle β of less than 90°, preferably 50°-80°, being furthermore preferred, 55°-75°, in particular, 57° to the top side of the belt conveyor.

28. The cable stacker (20) according to claim 22, wherein the first guide element (50) is spaced away from the belt conveyor (21), wherein, preferably, on a plane of the belt conveyor (21), the distance between the first guide element (50) and the belt conveyor (21) is between 20 and 50 mm, preferably between 30 and 40 mm.

29. The cable stacker (20) according to claim 22, wherein the side of the first guide element (50) facing a conveyor track (22) has a rounded shape.

30. The cable stacker (20) according to claim 22, wherein the first guide element (50) projects over the belt conveyor (21a) to at least a working height of the discharge device (60) above the belt conveyor (21a), wherein the height of this projection is at least about 20 mm and a maximum of about 60 mm.

31. A method for safely transporting a cable (80) on a cable stacker (20) according to claim 22, wherein the method comprises the following steps:
a) selecting at least one cable parameter;
b) transferring of the first guide element (50) to a first position along the conveying direction (X), wherein the first position is matched to a cable length of the cable to be conveyed;
c) checking the first position of the first guide element (50) using a sensor device (52);
d) transferring of control data to a control device (29, 99);
e) conveying the cable (80) on the first belt conveyor (21a).

32. The method according to claim 31, wherein the transfer of the first guide element (50) to the first position in step (b) is carried out by means of the drive device (51).

33. A cable stacker (20) comprising a belt conveyor (21) for transporting a cable (80) along a conveying direction (X) and a discharge device (60) for gripping, holding and dropping the cable into a collection tub (241) on a side of the belt conveyor, wherein the discharge device is rotated around an axis aligned transversely to the conveying direction and approximately perpendicular to the belt conveyor, and the axis positioned above the belt conveyor, wherein a first guide element (50) is arranged in an area of the collection tub and is positional longitudinally along the conveying direction (X).

34. The cable stacker (20) according to claim 33, wherein a positioning area of the first guide element (50) extends from a first position in the conveying direction in front of the axis to a second position in the conveying direction behind the axis.

35. The cable stacker (20) according to claim 34, wherein the discharge device comprises a swivel arm having a radius, and the positioning area of the first guide element (50) is at least 40%, preferably at least 50% of the radius.

36. A cable storage system (600) of a cable-processing machine comprising a swivelling gripper arm (604, 60) for holding, guiding and dropping a cable (80) in a working space (601) adjacent to a storage space (602) in a direction of cable feed, wherein the cable storage system has at least one boundary edge (603) which separates the working space from the storage space, wherein the boundary edge (603) is used as an inlet guide for guiding the gripper arm (604, 60) of the cable (80) to be deposited in the storage space, and the boundary edge (603), or the inlet guide, is arranged in a moveable manner.
